(19) United States
(12) Patent Application Publication
(10) Pub. No.: US 2005/0139643 A1
(43) Pub. Date: Jun. 30, 2005

(54) Method and system for applying solder

(75) Inventor: Kazuaki Ano, Hayami-gun (JP)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 10/748,381

(22) Filed: Dec. 30, 2003

(51) Int. Cl. B23K 31/00

(52) U.S. Cl. 228/248.1; 228/39; 228/41

(57) ABSTRACT

A method for applying solder paste to a circuit board includes covering a circuit board with a first stencil. The first stencil includes a first stencil hole. Solder paste is applied to a first area of the circuit board through the first stencil. The circuit board is then covered by a second stencil. The second stencil includes a second stencil hole and a void enclosure. The void enclosure covers the first area and prevents the second stencil from touching the first area. Solder paste is applied to a second area of the circuit board through the second stencil. The second stencil hole has a width greater than the first stencil hole in order to obtain different solder widths on the circuit board to accommodate components of different pitch sizes.

### TECHNICAL FIELD OF THE INVENTION

This invention relates in general to the production of electronic devices and more particularly to applying solder to circuit board assemblies.

### BACKGROUND OF THE INVENTION

Soldering is a common technique for mounting integrated circuits and other components to circuit boards. Solder paste is applied to specified points on the circuit board assembly where connections with a mounted component are desired. Then the component is mounted on the solder paste, and the solder paste is heated to liquefy it. After the liquefied solder paste cools, the solder paste forms a binding, conductive connection between the mounted component and the circuit board. If too much solder paste is deposited for connections to a particular component, the connections may run together creating shorts in the resulting circuit board assembly. However, if too little solder paste is deposited, the connections provide poor conductivity between the circuit board and mounted component and are more likely to break. As the size of electronic components continues to decrease, the acceptable margin of error in sizing the connections has fallen sharply. This leads to unnecessarily complex soldering techniques in the construction of circuit board assemblies, particularly where components of multiple different sizes are used.

Often solder paste is applied by an applicator dispensing a flow of solder paste while moving across the circuit board. Because differently sized connections require different amounts of solder paste and because conventional solder applicators often can not change dispensing rates within a single pass over the circuit board, applying multiple sizes of connections will often require the solder applicator to make multiple passes over the circuit board. In such a case, solder paste will be applied for the connections of a first size. Then, to avoid any disturbance of these solder deposits during application of a second set of connections, the components corresponding to the first set will be mounted, and the solder paste will be liquefied and cooled. After the first set of components are fully mounted and soldered, solder paste will be applied for connections of a second size, and the process will be repeated. This significantly adds to the production time and cost of circuit board assemblies.

### SUMMARY OF THE INVENTION

From the foregoing, it may be appreciated by those skilled in the art that a need has arisen for a more efficient method of providing multiple sizes of soldering connections on a single circuit board assembly. In accordance with the present invention, a method and system for applying solder paste to circuit boards are provided that substantially eliminate or reduce at least some of the disadvantages and problems associated with the previous techniques and systems.

In accordance with a particular embodiment of the present invention, a method for applying solder paste to a circuit board is disclosed which includes covering the circuit board with a first stencil. The first stencil includes a first stencil hole. The method also includes applying a solder paste to a first area of the circuit board through the first stencil and covering the circuit board with a second stencil. The second stencil includes a second stencil hole and a void enclosure. The void enclosure covers the first area of the circuit board. The method additionally includes applying a solder paste to a second area of the circuit board through the second stencil.

The present invention provides various technical advantages over conventional circuit board assembly techniques. In particular embodiments, a technical advantage may be more accurate sizing of circuit board assembly connections. Specifically, multiple sizes of connections may be formed with accuracy. Another technical advantage may be the elimination of unnecessary steps in the production process. All solder deposits can be heated at the same time.

Embodiments of the present invention may have some, all, or none of the following technical advantages. Other technical advantages of the present invention will be readily apparent to one skilled in the art from the figures, description, and claims included herein.

### BRIEF DESCRIPTION OF THE DRAWINGS

For a more complete understanding of the present invention and for further features and advantages thereof, reference is now made to the following description, taken in conjunction with the accompanying drawings, wherein like reference numerals represent like parts, in which:

FIG. 1 illustrates a cross sectional view of a first step in a method for applying connections to a circuit board;

FIG. 2 illustrates a cross sectional view of a circuit board and a first stencil during the first step in the method for applying connections to a circuit board;

FIG. 3 illustrates a cross sectional view of a circuit board and a second stencil during the second step in the method;

FIG. 4 illustrates a cross sectional view of a circuit board and electronic components during the third step in the method;

FIG. 5 illustrates a cross sectional view of a circuit board and a second stencil when a force is applied to the second stencil during the second step;

FIG. 6 illustrates a cross sectional view of a circuit board and a second stencil with void supports during the second step;

FIG. 7 illustrates various types and configurations of void supports;

FIG. 8 illustrates a cross sectional view of a circuit board and a needle array applicator during the second step; and

FIG. 9 is a flowchart detailing the method for applying solder paste according to a particular embodiment.

### DETAILED DESCRIPTION OF THE INVENTION

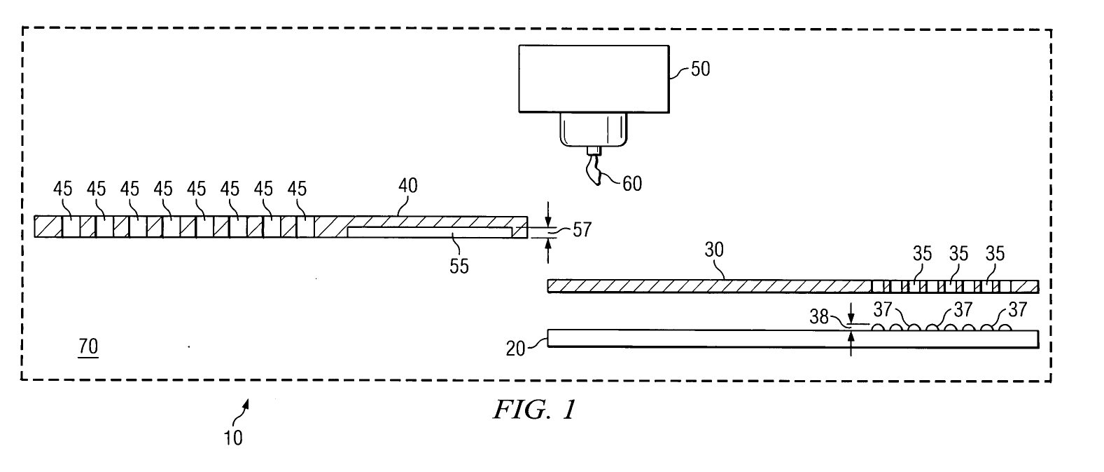

FIG. 1 illustrates a system 10 for applying solder paste 60 to a circuit board 20 to form soldered connections between circuit board 20 and electronic components to be mounted on circuit board 20. System 10 includes circuit board 20, a first stencil 30, a second stencil 40, and a solder applicator 50. Once solder paste 60 has been applied to circuit board 20 to form solder deposits, electronic components may be mounted. Solder deposits then may be heated to soften the solder deposits and cooled to harden the solder deposits around pins of the electronic components, forming a conductive bond between circuit board 20 and the electronic components. Additionally, by utilizing first stencil 30 and second stencil 40, system 10 may produce solder deposits of multiple sizes without heating the solder deposits multiple times.

First stencil 30 and second stencil 40 provide for selective application of solder paste 60 to circuit board 20. First stencil 30 includes one or more first stencil holes 35. First stencil 30 may include any number of first stencil holes 35 according to the amount and arrangement of soldering desired. When placed over circuit board 20, first stencil 30 blocks solder paste 60, preventing solder paste 60 from flowing down to circuit board 20 except through first stencil holes 35. Thus, by selective placement of first stencil holes 35, first stencil 30 can be designed to generate a solder connection pattern appropriate for circuit board 20 based on the electronic components to be mounted on circuit board 20, the type of connection desired, or any other suitable factors. First stencil 30 may be composed of metal, plastic, of any other material suitable for repelling solder paste 60.

Second stencil 40 includes second stencil holes 45, which operate similarly to first stencil holes 35, and void enclosure 55. When placed over circuit board 20, second stencil 40 blocks solder paste 60, preventing solder paste 60 from flowing down to circuit board 20 except through second stencil holes 45. Thus, by selective placement of second stencil holes 45, second stencil 40 can be designed to generate a connection pattern appropriate for circuit board 20 based on the electronic components to be mounted on circuit board 20, the type of connection desired, or any other suitable factor. Second stencil 40 may include any number of second stencil holes 45 according to the amount and arrangement of soldering desired.

Additionally, void enclosure 55 prevents a portion of second stencil 40 from touching first deposits 37 when second stencil 40 is placed over circuit board 20. This may prevent second stencil 40 from disturbing solder paste 60 that has been already deposited on circuit board 20. In general, void enclosure 55 may be designed and configured in any appropriate manner to prevent second stencil 40 from disturbing first deposits 37 made using first stencil 30. In a particular embodiment, void enclosure 55 has an enclosure height 57 that is greater than a first deposit height 38 of first deposits 37. Thus, with proper design and placement of first stencil holes 35, second stencil holes 45, and void enclosure 55, system 10 can produce a predetermined pattern of differently-sized solder deposits on circuit board 20 by sequential use of first stencil 30 and second stencil 40.

Solder applicator 50 applies solder paste 60 to circuit board 20. Solder applicator 50 may be any appropriate component capable of applying solder paste 60 as described below. In a particular embodiment, solder applicator 50 applies a continuous flow of solder paste 60 as solder applicator 50 moves across circuit board 20. The solder paste apply process can utilize a conventional squeezy printing method.

Circuit board 20 serves as a mounting platform for electronic components. Circuit board 20 connects to electronic components through solder connections and then provides electrical connections between the various electronic components through wires or other conductive elements. Circuit board 20 may be composed of plastic, glass, or any other suitable material.

Operator 70 represents a human operator or mechanical or electrical components capable of controlling the operation of solder applicator 50 and the placement of first stencil 30 and second stencil 40. For example, solder applicator 50, first stencil 30, and second stencil 40 may be integrated into a single machine into which circuit board 20 may be loaded. In this case, operator 70 may represent components, such as a stencil alignment module, of the machine that are capable of initiating a flow of solder paste 60 from solder applicator 50 and moving first stencil 30 and second stencil 40 into position over circuit board 20.

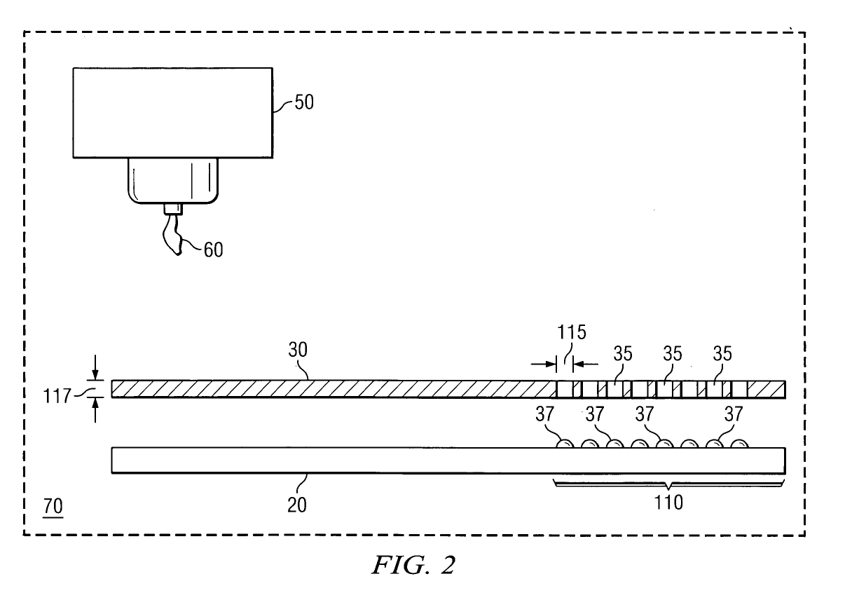

FIGS. 2-4 illustrate operation of system 10 according to a particular embodiment. Although FIGS. 2-4 illustrate operation of a system 10 that uses first stencil 30 and second stencil 40 and includes two stages of solder application, system 10 may be configured with appropriate modifications to incorporate any number of stencils and to include any number of solder application stages.

FIG. 2 illustrates a first step in the operation of a particular embodiment of system 10. Operator 70 places first stencil 30 over circuit board 20. Operator 70 then engages solder applicator 50. Solder applicator applies solder paste 60 over first stencil 30. First stencil 30 prevents solder paste 60 from flowing down to circuit board 20 except through first stencil holes 35. The flow of solder paste 60 through first stencil holes 35 creates solder deposits, first deposits 37, in a first area 110 of circuit board 20. In the example system 10, first deposits 37 share the width of the corresponding first stencil holes 35, i.e. a first width 115. In other systems 10, various factors, such as a tendency of solder paste 60 to cling to the sides of first stencil holes 35, may cause the width of first deposits 37 to vary from first width 115 of first stencil holes 35. Operator 70 then removes first stencil 30 from over circuit board 20.

First stencil 30 and first stencil holes 35 may be designed to produce certain characteristics in the resulting solder deposits generated by first stencil 30. As one example, first width 115 of first stencil holes 35 may be selected to produce first deposits 37 of a particular width. Furthermore, in a particular embodiment first stencil 30 may include first stencil holes 35 of multiple different widths producing first deposits 37 of multiple different widths. As another example, first stencil 30 may include a first height 117 that produces first deposits 37 of a particular height.

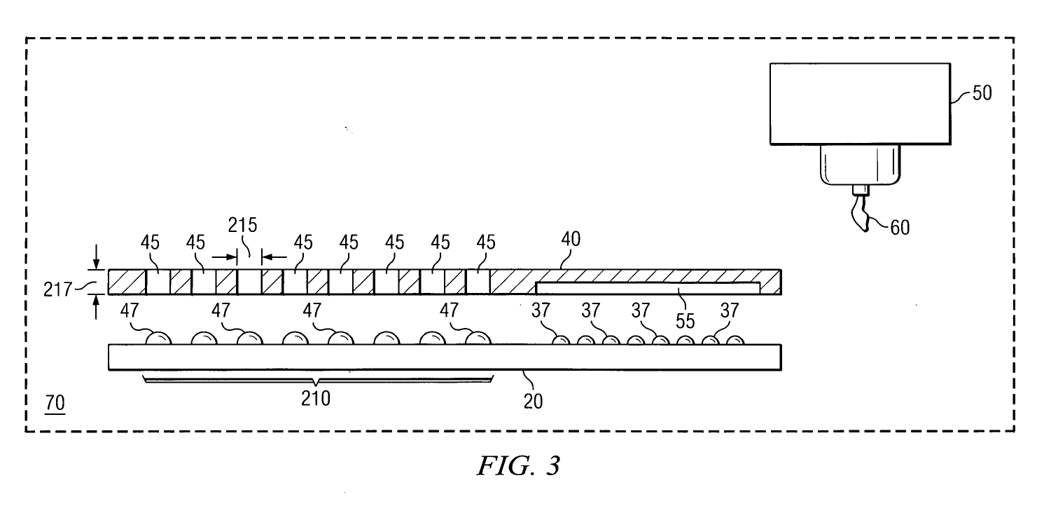

FIG. 3 illustrates a second step in the operation of system 10. After removing first stencil 30, operator 70 places second stencil 40 over circuit board 20. Second stencil 40 is designed so that void enclosure 55 covers first area 110 and second stencil 40 does not touch first deposits 37. As a result, second stencil 40 does not disturb first deposits 37 when operator 70 moves second stencil 40 into position over circuit board 20.

Operator 70 then engages solder applicator 50. Second stencil 40 prevents solder paste 60 from flowing down to circuit board 20 except through second stencil holes 45. The flow of solder paste 60 through second stencil holes 45 creates second deposits 47 in a second area 210 of circuit board 20. In the example system 10, second deposits 47 share the width of the corresponding second stencil holes 45, i.e. a second width 215. As noted above with respect to FIG. 2, in other systems 10, various factors may cause the width of second deposit 47 to vary from second width 215 of second stencil holes 45. Operator 70 then removes second stencil 40 from circuit board 20.

Like first stencil 30 and first stencil holes 35, second stencil 40 and second stencil holes 45 may be designed to produce certain characteristics in the resulting solder deposits generated by second stencil 40. As one example, second width 215 may be selected to produce second deposits 47 of a particular width. Moreover, in a particular embodiment, second stencil 40 may include second stencil holes 45 of multiple different widths producing second deposits 47 of multiple different widths. As another example, second stencil 40 may possess a second height 217 that produces second deposits 47 of a particular height.

Differences in first stencil 30 and second stencil 40 and/or first stencil holes 35 and second stencil holes 45, may result in differences in first deposits 37 and second deposits 47. For example, differences in first width 115 and second width 215 and/or first height 117 and second height 217 may cause differences in first deposits 37 and second deposits 47. Thus, first stencil 30 and second stencil 40 may be designed to facilitate mounting of components with varying solder requirements.

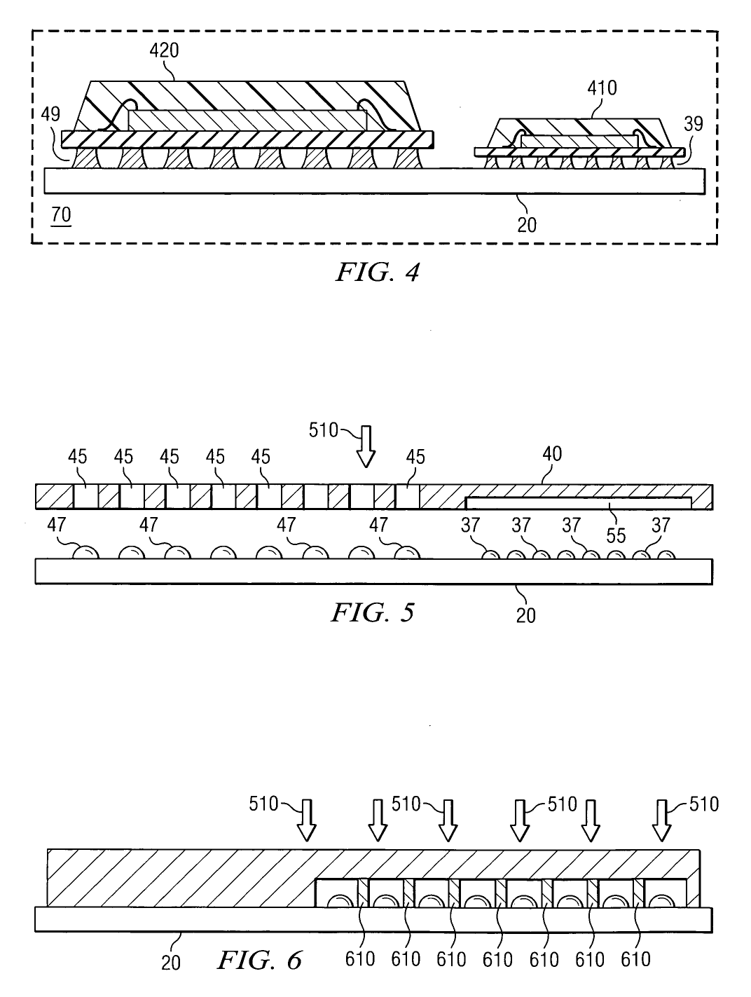

FIG. 4 illustrates a third step of the operation of system 10. After removing second stencil 40, operator 70 mounts electrical components on circuit board 20. As shown, the electrical components include a narrow pitch component 410 and a wide pitch component 420. In the example system 10, narrow pitch components 410 are appropriate for mounting on connections having a narrower pitch, such as those formed by first deposits 37. Similarly, wide pitch components 420 are appropriate for mounting on connections having a wider pitch, such as those formed by second deposits 47.

Operator 70 aligns pins or other connectors of narrow pitch components 410 and wide pitch components 420 with first deposits 37 and second deposits 47, respectively. Then, operator 70 heats first deposits 37 and second deposits 47 to soften first deposits 37 and second deposits 47. Operator 70 then cools, or allows to cool, first deposits 37 and second deposits 47. Operator 70 may execute these steps using conventional soldering techniques. For example, operator 70 may use one-time reflow techniques to complete the soldering process. After cooling, the solder of first deposits 37 form first conductive bonds 39 between narrow pitch components 410 and circuit board 20. Similarly, the solder of second deposits 47 form second conductive bonds 49 between wide pitch components 420 and circuit board 20. Thus, void enclosure 55 and first stencil 30 and second stencil 40 may operate to allow components with differing pitches, sizes, or pin heights, or, in general, components that require solder deposits of varying characteristics to be mounted on circuit board 20 without requiring repeated reflow of solder. The print sequence preferably starts from most finest pitch (corresponding to the amount of solder paste desired) and the order is preferably determined by the terminal pitch or solder land pitch. Although FIGS. 2-4 show a preferred ordering of steps that includes narrow pitch components 410 being mounted prior to wide pitch components 420, components may be mounted in any appropriate order using this method.

FIG. 5 illustrates the second step of operation of system 10 under different circumstances from FIG. 3. While in position over circuit board 20, second stencil 40 may undergo a pressure 510. Pressure 510 may cause void enclosure 55 of a particular embodiment of second stencil 40 to buckle. The buckling of void enclosure 55 may bring second stencil 40 into contact with first area 110 of circuit board 20, thereby disturbing first deposits 37.

FIG. 6 illustrates operation of a particular embodiment of second stencil 40 under similar circumstances to those illustrated by FIG. 5. Second stencil 40 includes void supports 610 to help support second stencil 40 and prevent buckling of void enclosure 55 as a result of pressure 510. Void supports 610 may be designed in conjunction with first stencil 30 to ensure void supports 610 are placed within void enclosure 55 in a configuration that prevents any void supports 610 from touching first deposits 37 while second stencil 40 is positioned over circuit board 20. Void supports 610 may be formed of the same material as second stencil 40 or any suitable alternative. Void supports 610 may be shaped and placed in any manner appropriate to prevent void enclosure 55 or void supports 610 from coming into contact with first deposits 37 as a result of pressure 510.

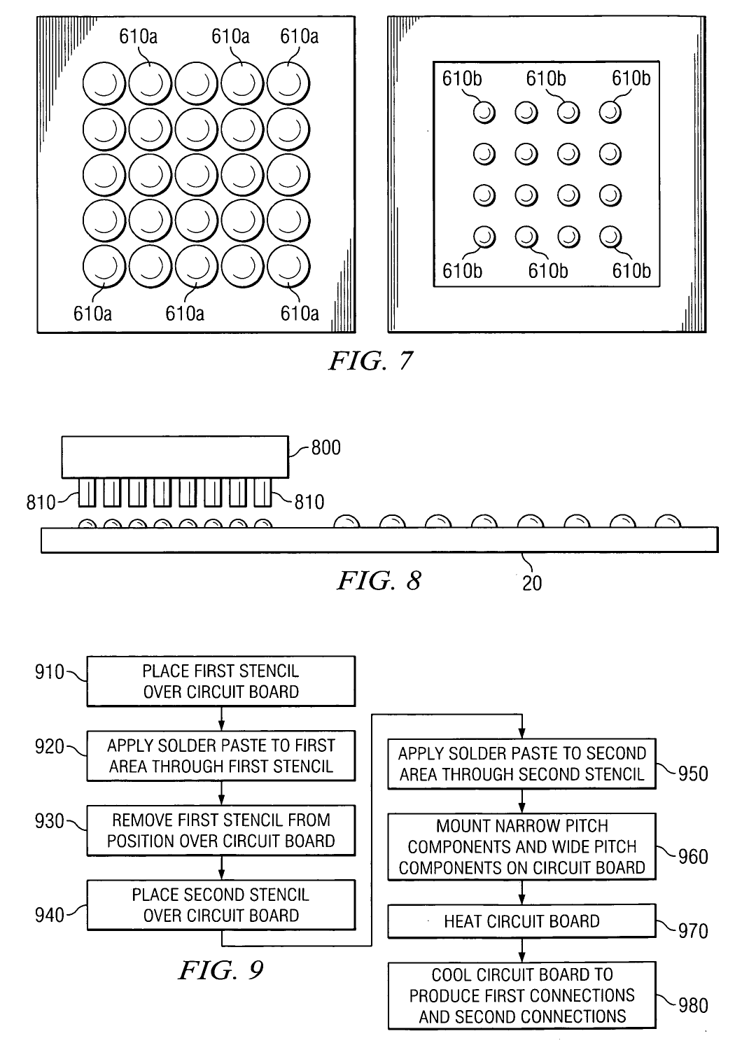

FIG. 7 illustrates two example configurations of void supports 610, pocket supports 610a and pillar supports 610b. Pocket supports 610a are formed by removing material from second stencil 40. Pocket supports 610a are sized and spaced so that pockets formed by pocket supports 610 align with first deposits 37 when second stencil 40 is placed in position over circuit board 20. In an embodiment of second stencil 40 that includes pocket supports 610a, void enclosure 55 may simply represent the collective area within the pockets formed by pocket supports 610a.

Pillar supports 610b are formed by adding material to void enclosure 55. Pillars supports 610b are sized and spaced so that pillar supports 610b rest between first deposits 37 when second stencil 40 is placed in position over circuit board 20. In an embodiment of second stencil 40 that includes pillar supports 610b, void enclosure 55 may represent the collective area surrounding the various pillar supports 610b.

FIG. 8 illustrates operation of a particular embodiment of system 10 that utilizes a needle array applicator 810 to apply solder paste 60 in addition or instead of solder applicator 50. Needle array applicator 810 is a device capable of dispensing solder paste 60 from any of a plurality of needle heads 820, each needle head 820 applying solder paste to a single point directly beneath that particular needle head 820. By locating needle array applicator 810 over a particular section of circuit board 20 and then selectively dispensing solder paste 60 from one or more needle heads 820, operator 70 can generate a solder paste 60 pattern similar to those described above, as being produced with first stencil 30 and second stencil 40. Furthermore, as with first stencil holes 35 and second stencil holes 45, needle heads 820 can be designed to produce certain characteristics, such as a desired width, in the solder deposits that needle array applicator 810 produces.

Needle array applicator 810 may eliminate the need for one or both of first stencil 30 and second stencil 40. System 10 may apply first deposits 37 as described above and then use needle array applicator 810 to apply second deposits 47 as shown in FIG. 8. Needle array applicator 810 can then apply second deposits 47 without disturbing first deposits 37, providing some or all of the benefits of second stencil 40 as described above. Although in FIG. 8, needle array applicator 810 is shown applying second deposits 47 that are appropriate for narrow pitch components 410, needle array applicator 810 may be configured to apply solder deposits of any type appropriate for circuit board 20.

FIG. 9 is a flow chart detailing a method of applying solder paste 60 according to a particular embodiment. At step 910, operator 70 places first stencil 30 in position over circuit board 20. Operator 70 applies solder paste 60 to first area 110 of circuit board 20 through first stencil holes 35 creating first deposits 37 at step 920. At step 930, operator 70 removes first stencil 30 from position over circuit board 20.

Operator 70 places second stencil 40 over circuit board 20 at step 940. At step 950, operator 70 applies solder paste 60 to second area 210 of circuit board 20 through second stencil holes 45 creating second deposits 47. Operator 70 mounts narrow pitch components 410 and wide pitch components 420 to circuit board 20 at step 960. At step 970, operator 70 heats circuit board 20 liquefying both first deposits 37 and second deposits 47. Operator 70 cools circuit board 20, at step 980, to produce first conductive bonds 39 and second conductive bonds 49 between circuit board 20 and narrow pitch components 410 and wide pitch components 420, respectively.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. A method for applying solder paste to a circuit board comprising:
covering a circuit board with a first stencil, wherein the first stencil comprises a first stencil hole;
applying a solder paste to a first area of a circuit board through the first stencil;
covering the circuit board with a second stencil, the second stencil comprises a second stencil hole and a void enclosure, and wherein the void enclosure covers the first area and prevents the second stencil from touching the first area; and
applying a solder paste to a second area of the circuit board through the second stencil.

2. The method of claim 1, wherein applying a solder paste to a first area comprises forming a solder deposit on the first area, the solder deposit having a deposit height and wherein the deposit height is less than a height of the void enclosure.

3. The method of claim 1, wherein the first stencil hole has a first width and the second stencil hole has a second width, the second width being greater than the first width.

4. The method of claim 1, wherein the second stencil is operable, while covering the circuit board, to support a pressure without the second stencil touching the first area.

5. The method of claim 1, wherein the first stencil further comprises a plurality of first stencil holes, the first stencil holes having a first width, and wherein the void enclosure comprises a plurality of pockets, the pockets having a second width, the second width being greater than the first width.

6. The method of claim 1, wherein the first stencil further comprises a plurality of first stencil holes, the first stencil holes having a first width, and wherein the void enclosure comprises a plurality of pillars and wherein a distance greater than the first width exists between any two pillars.

7. The method of claim 1, wherein the first stencil comprises a first height and wherein the second stencil comprises a second height, the second height being greater than the first height.

8. The method of claim 1, wherein the first stencil comprises a first height and wherein the second stencil comprises a second height, the second height being less than the first height.

9. The method of claim 1, further comprising:
mounting electrical components to both the first area and the second area; and
heating solder paste applied to the first area and solder paste applied to the second area.

10. A method for applying solder paste to a circuit board comprising:
covering the circuit board with a stencil, wherein the stencil comprises a stencil hole, wherein the stencil hole has a first width;
applying a solder paste across a first area of the circuit board covered by the stencil;
applying a solder paste to a second area of the circuit board with a needle head applicator, wherein the needle head applicator includes one or more solder needles, each solder needle operable to apply a solder deposit of a second width to a specified point on the circuit board.

11. The method of claim 10, wherein the second width is greater than the first width.

12. The method of claim 10, wherein the first width is greater than the second width.

13. A system for applying solder paste to a circuit board comprising:
a first stencil including a first stencil hole, wherein the first stencil is operable to block a flow of solder paste except through the first stencil hole;
a second stencil including a second stencil hole and a void enclosure, wherein the second stencil is operable to block a flow of solder paste except through the second stencil hole and wherein the void enclosure is operable to prevent the second stencil from touching an area of a circuit board positioned underneath the second stencil;
a solder applicator, operable to dispense solder paste; and
a stencil alignment module operable to:
position the first stencil over the circuit board;
apply solder paste to a first area of the circuit board through the first stencil;
position the second stencil over the circuit board so that the void enclosure aligns with the first area; and
apply solder paste to a second area of the circuit board through the second stencil.

14. The system of claim 13, wherein the stencil alignment module is operable to apply a solder paste to a first area by forming a solder deposit on the first area, the solder deposit having a deposit height and wherein the deposit height is less than a height of the void enclosure.

15. The system of claim 13, wherein the first stencil hole has a first width and the second stencil hole has a second width, the second width being greater than the first width.

16. The system of claim 13, wherein the second stencil is operable, while covering the circuit board, to support a pressure without the second stencil touching the first area.

17. The system of claim 13, wherein the first stencil further comprises a plurality of first stencil holes, the first stencil holes having a first width, and wherein the void enclosure comprises a plurality of pockets, the pockets having a second width, the second width being greater than the first width.

18. The system of claim 13, wherein the first stencil further comprises a plurality of first stencil holes, the first stencil holes having a first width, and wherein the void enclosure comprises a plurality of pillars and wherein a distance greater than the first width exists between any two pillars.

19. The system of claim 13, wherein the first stencil comprises a first height and the second stencil comprises a second height, the second height being greater than the first height 20. The system of claim 13, wherein the stencil positioning module is further operable to:
mount electrical components to the both first area and the second area; and
heat solder paste applied to the first area and solder paste applied to the second area.
